(19) United States
(12) Patent Application Publication
(10) Pub. No.: US 2024/0128485 A1
(43) Pub. Date: Apr. 18, 2024

(54) Fuel Cell Aparatus

(71) Applicants: Hyundai Motor Company, Seoul (KR); Kia Corporation, Seoul (KR)

(72) Inventor: Jae Min Ahn, Yongin-si (KR)

(21) Appl. No.: 18/314,945

(22) Filed: May 10, 2023

(30) Foreign Application Priority Data
Oct. 17, 2022 (KR) 10-2022-0133125

(51) Int. Cl. H01M 8/2475; H01M 8/0258; H01M 8/0273; H01M 8/0284

(52) U.S. Cl. CPC H01M 8/2475; H01M 8/0258; H01M 8/0273; H01M 8/0284

(57) ABSTRACT

A fuel cell apparatus of the disclosure includes a cell stack including a plurality of unit cells stacked in a first direction, first and second end plates, which are disposed on respective lateral ends of the cell stack and each of which is formed such that a metal portion is enveloped by a resin portion, a sacrificial electrode disposed on a resin portion of the second end plate adjacent to a cell having the highest potential among the unit cells, among the first and second end plates, an outer coupling member coupled to an outer surface of the second end plate that is opposite an inner surface of the second end plate, which faces the cell stack, so as to be in contact with and support the sacrificial electrode, and a first sealing member disposed between the outer surface of the second end plate and the outer coupling member.

### CROSS-REFERENCE TO RELATED APPLICATIONS

This application claims the benefit of Korean Patent Application No. 10-2022-0133125, filed on Oct. 17, 2022, which is hereby incorporated by reference as if fully set forth herein.

### TECHNICAL FIELD

Embodiments relate to a fuel cell apparatus.

### BACKGROUND

In general, a fuel cell includes a cell stack, in which a plurality of unit cells is stacked, and each of the plurality of unit cells generates electricity using air supplied to one surface of a polymer electrolyte membrane and hydrogen supplied to the opposite surface of the polymer electrolyte membrane.

A separator of a fuel cell is deteriorated in durability due to corrosion when used for a long time. In order to prevent oxidation of the separator, a sacrificial electrode is provided so as to be corroded instead of the separator. The use of the sacrificial electrode prevents metal of the separator from being oxidized, thereby improving the durability of the fuel cell stack. The sacrificial electrode may include metal having a lower potential than the metal of the separator. However, in the case of conventional fuel cells, it is not easy to replace a sacrificial electrode. Therefore, research with the goal of solving this problem is underway.

### SUMMARY

Accordingly, embodiments are directed to a fuel cell apparatus that substantially obviates one or more problems due to limitations and disadvantages of the related art.

Embodiments provide a fuel cell apparatus including a sacrificial electrode capable of preventing corrosion of a cell having a high potential and of being easily replaced.

However, objects to be accomplished by the embodiments are not limited to the above-mentioned objects, and other objects not mentioned herein will be clearly understood by those skilled in the art from the following description.

A fuel cell apparatus according to an embodiment may include a cell stack including a plurality of unit cells stacked in a first direction, first and second end plates, which are disposed on respective lateral ends of the cell stack and each of which is formed such that a metal portion is enveloped by a resin portion, a sacrificial electrode disposed on a resin portion of the second end plate adjacent to a cell having the highest potential among the plurality of unit cells, among the first and second end plates, an outer coupling member coupled to an outer surface of the second end plate that is opposite an inner surface of the second end plate, which faces the cell stack, so as to be in contact with and support the sacrificial electrode, and a first sealing member disposed between the outer surface of the second end plate and the outer coupling member.

In an example, the second end plate may include a coolant inlet formed to allow a coolant to flow into the cell stack therethrough and to allow the resin portion to be disposed therein and a coolant outlet formed to allow a coolant flowing out of the cell stack to be discharged therethrough and to allow the resin portion to be disposed therein. The sacrificial electrode may include a flow path portion disposed on the resin portion in a flow path in at least one of the coolant inlet or the coolant outlet and a bent portion bent and extending from the flow path portion in a second direction, which is perpendicular to the first direction, so as to be disposed between the resin portion of the second end plate and the outer coupling member.

In an example, the first sealing member may be disposed between the outer coupling member and the bent portion of the sacrificial electrode.

In an example, the first sealing member may be disposed between the resin portion adjacent to the bent portion of the sacrificial electrode in the second direction and the outer coupling member.

A fuel cell apparatus according to another embodiment may include a plurality of stack modules, a manifold block disposed on one of two lateral ends of the plurality of stack modules, and a side cover disposed on the remaining one of the two lateral ends of the plurality of stack modules. Each of the plurality of stack modules may include a cell stack including a plurality of unit cells stacked in a first direction, first and second end plates, which are respectively disposed between one lateral end of the cell stack and the manifold block and between the opposite lateral end of the cell stack and the side cover and each of which is formed such that a metal portion is enveloped by a resin portion, a sacrificial electrode disposed on a resin portion of the second end plate adjacent to a cell having the highest potential among the plurality of unit cells, among the first and second end plates, and a second sealing member disposed between an outer surface of the second end plate that is opposite an inner surface of the second end plate, which faces the cell stack, and the side cover.

In an example, the fuel cell apparatus may further include an outer coupling member coupled to an outer surface of the side cover that is opposite an inner surface of the side cover, which faces the second end plate.

In an example, the outer coupling member may include a coolant driving device component (balance of plant (BOP)).

In an example, the outer coupling member may include a pipe.

In an example, the second end plate included in each of the plurality of stack modules may include a coolant inlet formed to allow a coolant to flow into the cell stack therethrough and to allow the resin portion to be disposed therein and a coolant outlet formed to allow a coolant flowing out of the cell stack to be discharged therethrough and to allow the resin portion to be disposed therein.

In an example, the sacrificial electrode may include a flow path portion disposed on the resin portion in a flow path in at least one of the coolant inlet or the coolant outlet.

In an example, the sacrificial electrode may include a bent portion bent and extending from the flow path portion in a second direction, which is perpendicular to the first direction, so as to be disposed between the resin portion of the second end plate and the side cover.

In an example, the second sealing member may be disposed between the side cover and the bent portion.

In an example, the second sealing member may be disposed between the resin portion adjacent to the bent portion of the sacrificial electrode in the second direction and the side cover.

In an example, the sacrificial electrode may include a bent portion bent and extending from the flow path portion in a second direction, which is perpendicular to the first direction, so as to be disposed between the side cover and the outer coupling member.

In an example, the second sealing member may be disposed between the side cover and the resin portion of the second end plate.

In an example, the fuel cell apparatus may further include a third sealing member disposed between the outer coupling member and the side cover.

In an example, the third sealing member may be disposed between the outer coupling member and the bent portion of the sacrificial electrode.

In an example, the third sealing member may be disposed between the side cover adjacent to the bent portion of the sacrificial electrode in the second direction and the outer coupling member.

In an example, the fuel cell apparatus may further include a fourth sealing member disposed between the resin portion of the second end plate and the flow path portion or between the resin portion of the second end plate and the bent portion.

In an example, a bending angle between the bent portion and the flow path portion may be less than 90° by 1° to 5°.

In an example, the resin portion of the second end plate may have a groove portion formed therein to allow at least part of the bent portion to be disposed therein, and the thickness of the bent portion in the first direction may be greater than the depth of the groove portion in the first direction.

In an example, the resin portion of the second end plate may have a groove portion formed therein to allow at least part of the bent portion to be disposed therein, and the thickness of the bent portion in the first direction may be less than the depth of the groove portion in the first direction.

### BRIEF DESCRIPTION OF THE DRAWINGS

The accompanying drawings, which are included to provide a further understanding of the disclosure and are incorporated in and constitute a part of this application, illustrate embodiment(s) of the disclosure and together with the description serve to explain the principle of the disclosure. In the drawings:

FIG. 1A is a front perspective view of a fuel cell apparatus according to an embodiment;

FIG. 1B is a rear perspective view of the fuel cell apparatus according to the embodiment;

FIG. 2 is a cross-sectional view of the fuel cell apparatus according to the embodiment;

FIG. 3 is a partial cross-sectional view of a fuel cell apparatus according to an embodiment, taken along line I-I′ shown in FIG. 1B;

FIG. 4 is a partial cross-sectional view of a fuel cell apparatus according to another embodiment, taken along line I-I′ shown in FIG. 1B;

FIG. 5A is a partial exploded cross-sectional view of a sacrificial electrode and a second end plate in the fuel cell apparatus shown in FIG. 3;

FIG. 5B is a partial exploded cross-sectional view of a sacrificial electrode and a second end plate in the fuel cell apparatus shown in FIG. 4;

FIG. 6 is an exploded cross-sectional view of the sacrificial electrode and the second end plate shown in FIG. 3;

FIG. 7A is a front perspective view of a fuel cell apparatus according to another embodiment;

FIG. 7B is a rear perspective view of the fuel cell apparatus according to the other embodiment;

FIG. 8 is a cross-sectional view of an embodiment of the fuel cell apparatus taken along line II-II′ shown in FIG. 7B;

FIG. 9 is a partial cross-sectional view of another embodiment of the fuel cell apparatus;

FIG. 10 is a partial cross-sectional view of an embodiment of the fuel cell apparatus;

FIG. 11 is a partial cross-sectional view of another embodiment of the fuel cell apparatus;

FIG. 12A is a partial exploded cross-sectional view of the fuel cell apparatus shown in FIG. 10; and

FIG. 12B is a partial exploded cross-sectional view of the fuel cell apparatus shown in FIG. 11.

### DETAILED DESCRIPTION

The present disclosure will now be described more fully hereinafter with reference to the accompanying drawings, in which various embodiments are shown. The examples, however, may be embodied in many different forms and should not be construed as being limited to the embodiments set forth herein. Rather, these embodiments are provided so that this disclosure will be more thorough and complete, and will more fully convey the scope of the disclosure to those skilled in the art.

It will be understood that when an element is referred to as being “on” or “under” another element, it may be directly on/under the element, or one or more intervening elements may also be present.

When an element is referred to as being “on” or “under”, “under the element” as well as “on the element” may be included based on the element.

In addition, relational terms, such as “first”, “second”, “on/upper part/above” and “under/lower part/below”, are used only to distinguish between one subject or element and another subject or element, without necessarily requiring or involving any physical or logical relationship or sequence between the subjects or elements.

Hereinafter, fuel cell apparatuses 100A and 100B according to embodiments will be described with reference to the accompanying drawings. The fuel cell apparatuses 100A and 100B will be described using the Cartesian coordinate system (x-axis, y-axis, z-axis) for convenience of description, but may also be described using other coordinate systems. In the Cartesian coordinate system, the x-axis, the y-axis, and the z-axis are perpendicular to each other, but the embodiments are not limited thereto. That is, the x-axis, the y-axis, and the z-axis may intersect each other obliquely. Hereinafter, for convenience of description, the +x-axis direction or the −x-axis direction will be referred to as a “first direction”, the +z-axis direction or the −z-axis direction will be referred to as a “second direction”, and the +y-axis direction or the −y-axis direction will be referred to as a “third direction”.

First, a fuel cell apparatus 100A according to an embodiment will be described below with reference to the accompanying drawings.

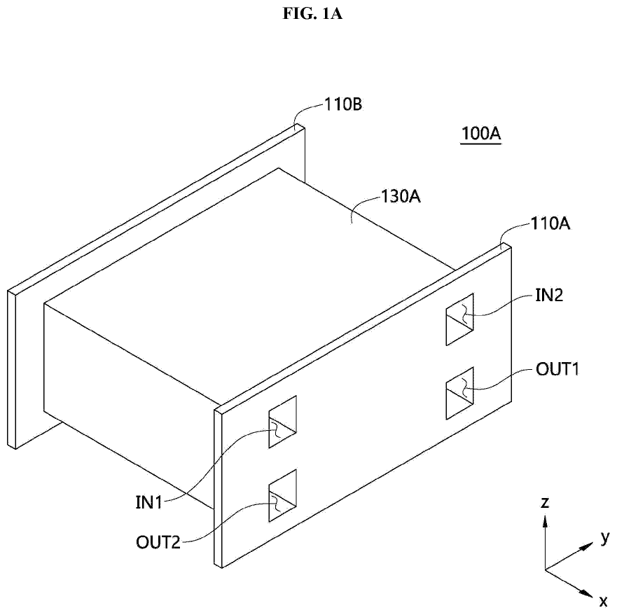

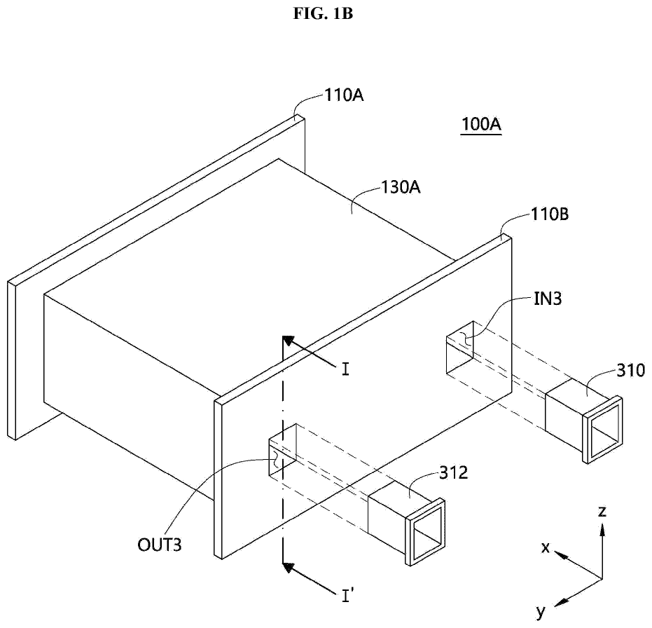

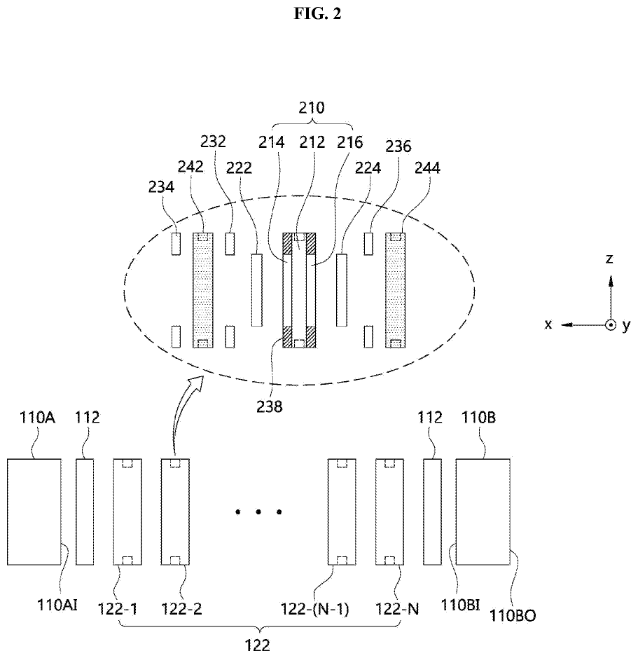

FIG. 1A is a front perspective view of the fuel cell apparatus 100A according to the embodiment, FIG. 1B is a rear perspective view of the fuel cell apparatus 100A according to the embodiment, and FIG. 2 is a cross-sectional view of the fuel cell apparatus 100A according to the embodiment. Illustration of an enclosure 130A and sacrificial electrodes (or sacrificial oxidizing electrodes or sacrificial anodes) 310 and 312 shown in FIGS. 1A and 1B is omitted from FIG. 2.

A fuel cell included in the fuel cell apparatus 100A may be, for example, a polymer electrolyte membrane fuel cell (or a proton exchange membrane fuel cell) (PEMFC), which has been studied most extensively as a power source for driving vehicles. However, the embodiments are not limited to any specific form of the fuel cell.

The fuel cell may include end plates (or pressing plates or compression plates) 110A and 110B, a current collector 112, a cell stack (or a power generation module) 122, and an enclosure 130A.

The enclosure 130A shown in FIGS. 1A and 1B may be coupled to the end plates 110A and 110B, and may be disposed so as to surround at least part of the side portion of the cell stack 122 disposed between the end plates 110A and 110B. The enclosure 130A may serve to clamp a plurality of unit cells together with the end plates 110A and 110B in the first direction. In other words, the clamping pressure of the cell stack 122 may be maintained by the end plates 110A and 110B, which have rigid body structures, and the enclosure 130A.

Alternatively, unlike what is illustrated, the fuel cell may include a clamping member (not shown), which has a bar shape, a long bolt shape, a belt shape, or a rigid rope shape to clamp the plurality of unit cells instead of the enclosure 130A. The embodiments are not limited to any specific structure for clamping the plurality of unit cells.

The end plates 110A and 110B may be disposed on at least one of both lateral ends (portions) of the cell stack 122, and may support and fix the plurality of unit cells. That is, the first end plate 110A may be disposed on one of both lateral ends of the cell stack 122, and the second end plate 110B may be disposed on the other of both lateral ends of the cell stack 122.

Each of the first and second end plates 110A and 110B may include a metal portion (or a metal insert) M having high rigidity in order to withstand the internal surface pressure of the cell stack 122 and to clamp the plurality of unit cells. For example, the metal portion M may be embodied by machining a metal material, such as aluminum or an aluminum composite material.

In addition, each of the end plates 110A and 110B is a part for clamping high-voltage parts, and thus needs to be insulative. Therefore, each of the end plates 110A and 110B may further include a resin portion R, which is insulative and is disposed around each of a fluid inlet and a fluid outlet to be described later, which need to be insulated. The resin portion R may include an insulative material, for example a plastic material. In this case, the resin portion R may include a nylon-based material (PPA, PPS, PA66, or the like).

Each of the first and second end plates 110A and 110B may be formed such that the metal portion M is enveloped by the resin portion R.

The fuel cell may include a plurality of manifolds M. The plurality of manifolds may include fluid inflow portions, into which a fluid flows so as to be supplied to the cell stack 122, and fluid outflow portions, through which a fluid discharged from the cell stack 122 flows to the outside.

In detail, the fluid inflow portions may include a first inflow communication portion (or a first inlet manifold) IN1, a second inflow communication portion (or a second inlet manifold) IN2, and a third inflow communication portion (or a third inlet manifold) IN3. The fluid outflow portions may include a first outflow communication portion (or a first outlet manifold) OUT1, a second outflow communication portion (or a second outlet manifold) OUT2, and a third outflow communication portion (or a third outlet manifold) OUT3.

One of the first and second inflow communication portions IN1 and IN2 may correspond to a hydrogen inlet through which hydrogen, which is a fluid supplied as a reactant gas from the outside, is introduced into the cell stack 122, and the other of the first and second inflow communication portions IN1 and IN2 may correspond to an oxygen inlet through which oxygen, which is a fluid supplied as a reactant gas from the outside, is introduced into the cell stack 122. In addition, one of the first and second outflow communication portions OUT1 and OUT2 may correspond to a hydrogen outlet through which hydrogen, which is a reactant gas, and condensed water are discharged as fluids out of the cell stack 122, and the other of the first and second outflow communication portions OUT1 and OUT2 may correspond to an oxygen outlet through which oxygen, which is a reactant gas, and condensed water are discharged as fluids out of the cell stack 122.

In an example, the first inflow communication portion IN1 may correspond to an oxygen inlet, the second inflow communication portion IN2 may correspond to a hydrogen inlet, the first outflow communication portion OUT1 may correspond to an oxygen outlet, and the second outflow communication portion OUT2 may correspond to a hydrogen outlet.

In addition, the third inflow communication portion IN3 may correspond to a coolant inlet into which a cooling medium (e.g. coolant) is introduced as a fluid from the outside, and the third outflow communication portion OUT3 may correspond to a coolant outlet through which a cooling medium is discharged as a fluid to the outside.

The first and second outflow communication portions OUT1 and OUT2 may be disposed below the first and second inflow communication portions IN1 and IN2, the first inflow communication portion IN1 and the first outflow communication portion OUT1 may be disposed at positions separated from each other in an oblique direction, and the second inflow communication portion IN2 and the second outflow communication portion OUT2 may be disposed at positions separated from each other in an oblique direction. Due to this disposition of the first and second inflow communication portions IN1 and IN2 and the first and second outflow communication portions OUT1 and OUT2, condensed water may be discharged from the lower portions of the unit cells included in the cell stack 122, or may remain in the lower portions of the unit cells due to gravity.

The first and second inflow communication portions IN1 and IN2 and the first and second outflow communication portions OUT1 and OUT2 may be included in any one of the first and second end plates 110A and 110B (e.g. the first end plate 110A, as shown in FIG. 1A), and the third inflow communication portion IN3 and the third outflow communication portion OUT3 may be included in the other of the first and second end plates 110A and 110B (e.g. the second end plate 110B shown in FIG. 1B).

Alternatively, all of the first to third inflow communication portions IN1, IN2, and IN3 and the first to third outflow communication portions OUT1, OUT2, and OUT3 may be included in any one of the first and second end plates 110A and 110B.

The fuel cell apparatuses 100A and 100B according to the embodiments are not limited to any specific disposition pattern of the first to third inflow communication portions IN1, IN2, and IN3 and the first to third outflow communication portions OUT1, OUT2, and OUT3. That is, the first to third inflow communication portions IN1, IN2, and IN3 and the first to third outflow communication portions OUT1, OUT2, and OUT3 may be located in the first and second end plates 110A and 110B in various patterns.

Referring to FIG. 2, the cell stack 122 may include a plurality of unit cells 122-1 to 122-N, which are stacked in the first direction. Here, “N” is a positive integer of 1 or greater, and may range from several tens to several hundreds. “N” may be determined depending on the intensity of the power to be supplied from the fuel cell to a load. Here, the “load” may refer to a part requiring power in a vehicle that uses the fuel cell.

Each unit cell 122-n may include a membrane electrode assembly (MEA) 210, gas diffusion layers (GDLs) 222 and 224, gaskets 232, 234, and 236, and separators (or bipolar plates) 242 and 244. Here, 1≤n≤N.

The membrane electrode assembly 210 has a structure in which catalyst electrode layers, in which electrochemical reactions occur, are attached to both sides of an electrolyte membrane through which hydrogen ions move. Specifically, the membrane electrode assembly 210 may include a polymer electrolyte membrane (or a proton exchange membrane) 212, a fuel electrode (or a hydrogen electrode or an anode) 214, and an air electrode (or an oxygen electrode or a cathode) 216. In addition, the membrane electrode assembly 210 may further include a sub-gasket 238.

The polymer electrolyte membrane 212 is disposed between the fuel electrode 214 and the air electrode 216.

In the fuel cell, hydrogen, which is a fuel, may be supplied to the fuel electrode 214 through the first separator 242, and air containing oxygen, which is an oxidizer, may be supplied to the air electrode 216 through the second separator 244.

The hydrogen supplied to the fuel electrode 214 is decomposed into hydrogen ions (protons) (H+) and electrons (e−) by the catalyst. The hydrogen ions alone may be selectively transferred to the air electrode 216 through the polymer electrolyte membrane 212, and at the same time, the electrons may be transferred to the air electrode 216 through the gas diffusion layers 222 and 224, which are conductors, and the separators 242 and 244. In order to realize the above operation, a catalyst layer may be applied to each of the fuel electrode 214 and the air electrode 216. The movement of the electrons described above causes the electrons to flow through an external conductive wire, thus generating current. That is, the fuel cell may generate electric power due to electrochemical reaction between hydrogen, which is a fuel, and oxygen contained in the air.

In the air electrode 216, the hydrogen ions supplied through the polymer electrolyte membrane 212 and the electrons transferred through the separators 242 and 244 meet oxygen in the air supplied to the air electrode 216, thus causing a reaction that generates water (hereinafter referred to as “condensed water” or “product water”). The condensed water generated in the air electrode 216 may penetrate the polymer electrolyte membrane 212 and may be transferred to the fuel electrode 214.

In some cases, the fuel electrode 214 may be referred to as an anode, and the air electrode 216 may be referred to as a cathode. Alternatively, the fuel electrode 214 may be referred to as a cathode, and the air electrode 216 may be referred to as an anode.

The gas diffusion layers 222 and 224 serve to uniformly distribute hydrogen and oxygen, which are reactant gases, and to transfer the generated electrical energy. To this end, the gas diffusion layers 222 and 224 may be disposed on respective sides of the membrane electrode assembly 210. That is, the first gas diffusion layer 222 may be disposed on the left side of the fuel electrode 214, and the second gas diffusion layer 224 may be disposed on the right side of the air electrode 216.

The first gas diffusion layer 222 may serve to diffuse and uniformly distribute hydrogen supplied as a reactant gas through the first separator 242, and may be electrically conductive.

The second gas diffusion layer 224 may serve to diffuse and uniformly distribute air supplied as a reactant gas through the second separator 244, and may be electrically conductive.

Each of the first and second gas diffusion layers 222 and 224 may be a microporous layer in which fine carbon fibers are combined. However, the embodiments are not limited to any specific forms of the first and second gas diffusion layers 222 and 224.

The gaskets 232, 234, and 236 serve to maintain the airtightness and clamping pressure of the cell stack at an appropriate level with respect to the reactant gases and the coolant, to disperse the stress when the separators 242 and 244 are stacked, and to independently seal the flow paths.

The separators 242 and 244 may serve to move the reactant gases and the cooling medium and to separate each of the unit cells from the other unit cells. In addition, the separators 242 and 244 may serve to structurally support the membrane electrode assembly 210 and the gas diffusion layers 222 and 224 and to collect the generated current and transfer the collected current to the current collector 112.

The separators 242 and 244 may be respectively disposed outside the gas diffusion layers 222 and 224. That is, the first separator 242 may be disposed on the left side of the first gas diffusion layer 222, and the second separator 244 may be disposed on the right side of the second gas diffusion layer 224.

The first separator 242 serves to supply hydrogen, which is a reactant gas, to the fuel electrode 214 through the first gas diffusion layer 222. To this end, the first separator 242 may include an anode plate (AP), in which a channel (i.e. a passage or a flow path) through which hydrogen can flow is formed.

The second separator 244 serves to supply air, which is a reactant gas, to the air electrode 216 through the second gas diffusion layer 224. To this end, the second separator 244 may include a cathode plate (CP), in which a channel through which air containing oxygen can flow is formed. In addition, each of the first and second separators 242 and 244 may form a channel through which a cooling medium can flow.

For example, each of the first and second separators 242 and 244 may include the first to third inflow communication portions IN1, IN2, and IN3 and the first to third outflow communication portions OUT1, OUT2, and OUT3, or may include some of the above communication portions.

In other words, the reactant gases required for the membrane electrode assembly 210 may be introduced into the cell through the first and second inflow communication portions IN1 and IN2, and gas or liquid, in which the reactant gases humidified and supplied to the cell and the condensed water generated in the cell are combined, may be discharged to the outside of the fuel cell through the first and second outflow communication portions OUT1 and OUT2.

The current collector 112 may be disposed between the cell stack 122 and each of the inner surfaces 110AI and 110BI of the first and second end plates 110A and 110B that face the cell stack 122.

The current collector 112 serves to collect electrical energy generated by the flow of electrons in the cell stack 122 and to supply the same to the load of the vehicle in which the fuel cell is used. In an example, the current collector 112 may be implemented as a metal plate, which is made of an electrically conductive material, and may be conductively connected to the cell stack 122.

When the cell stack 122 generates power, a separator of a cell having a high potential among the plurality of cells may be corroded due to a potential difference. Therefore, the fuel cell apparatus 100A according to the embodiment may include sacrificial electrodes 310 and 312 in order to suppress corrosion. The sacrificial electrodes 310 and 312 may be disposed close to a reaction cell.

Hereinafter, the fuel cell apparatus according to the embodiment including the sacrificial electrodes 310 and 312 will be described with reference to the accompanying drawings.

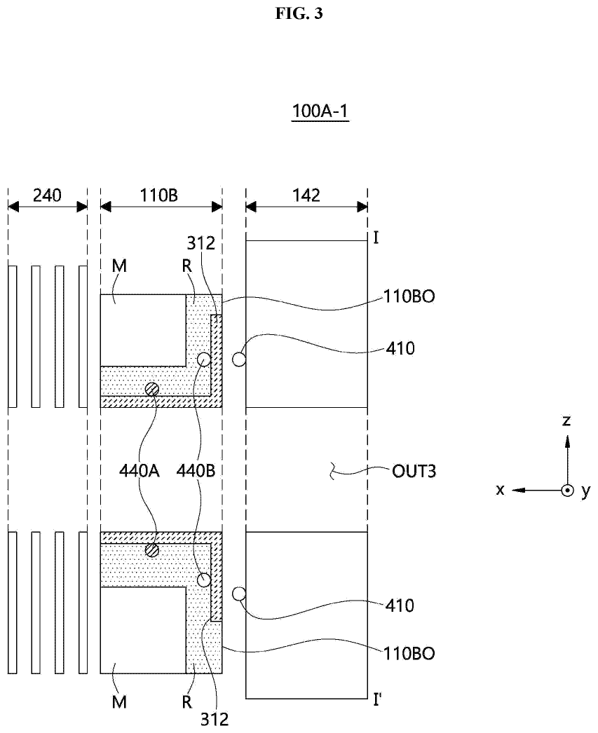

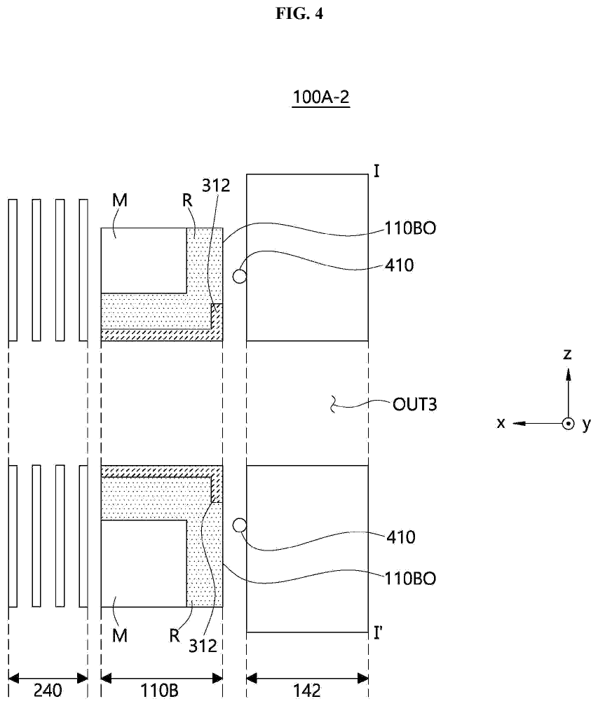

FIG. 3 is a partial cross-sectional view of a fuel cell apparatus 100A-1 according to an embodiment, taken along line I-I′ shown in FIG. 1B, and FIG. 4 is a partial cross-sectional view of a fuel cell apparatus 100A-2 according to another embodiment, taken along line I-I′ shown in FIG. 1B. For convenience of description, illustration of the enclosure 130A shown in FIG. 1B and the current collector 112 shown in FIG. 2 is omitted from FIGS. 3 and 4, and only a separator 240 among the components of the cell stack 122 is shown in FIGS. 3 and 4. Therefore, the separator 240 shown in FIGS. 3 and 4 corresponds to the separators 242 and 244 of each unit cell shown in FIG. 2.

The configuration of the sacrificial electrode 312 shown in FIG. 1B will be described with reference to FIGS. 3 and 4. Since the sacrificial electrode 310 has the same configuration as the sacrificial electrode 312, the following description may also be applied to the sacrificial electrode 310.

The sacrificial electrodes 310 and 312 may be disposed on an end plate adjacent to a cell having the highest potential among the plurality of unit cells 122-1 to 122-N, among the first and second end plates 110A and 110B.

The separator 240 (242 or 244) may be made of a graphite-based material, a graphite-based composite material, or a metal-based material, but the embodiments are not limited to any specific material of the separator 240 (242 or 244). For example, the separator 240 (242 or 244) may be made of steel use stainless (SUS) or a Ti-based metal material.

The sacrificial electrodes 310 and 312 may be made of a metal material having a lower potential than the material of the separator 240 (242 or 244). For example, the sacrificial electrodes 310 and 312 may be made of metal such as SUS.

A cell having the highest potential among the plurality of unit cells 122-1 to 122-N may be the N^{th} cell 122-N. Accordingly, the sacrificial electrodes 310 and 312 may be disposed on the second end plate 110B, as shown in FIGS. 1B, 3, and 4. Therefore, for convenience of description, only the second end plate 110B, on which the sacrificial electrodes 310 and 312 are disposed, is shown in FIGS. 3 and 4.

The second end plate 110B shown in FIGS. 3 and 4 corresponds to an embodiment of the second end plate 110B shown in FIGS. 1A, 1B, and 2.

The resin portion R may be disposed on a portion of the inner surface 110BI of the second end plate 110B, other than a reaction surface (not shown), and may be disposed in the flow path in each of the coolant inlet IN3 and the coolant outlet OUT3. In the second end plate 110B, the coolant inlet IN3 and the coolant outlet OUT3 may be covered with the resin portion R in order to ensure insulation performance.

The embodiments are not limited to any specific disposition pattern of the metal portion M and the resin portion R, so long as the resin portion R is capable of being disposed in each of the coolant outlet OUT3 and the coolant inlet IN3, as shown in FIGS. 3 and 4.

According to the embodiment, as shown in FIGS. 3 and 4, the sacrificial electrodes 310 and 312 may be disposed on the resin portion R of the second end plate 110B. In addition, the sacrificial electrodes 310 and 312 may be disposed on the resin portion R in the flow path in at least one of the coolant inlet IN3 or the coolant outlet OUT3.

In an example, as shown in FIG. 1B, the sacrificial electrode 310 may be disposed in the coolant inlet IN3, and the sacrificial electrode 312 may be disposed in the coolant outlet OUT3.

Alternatively, unlike what is shown, the sacrificial electrode 310 may be disposed in the coolant inlet IN3, but the sacrificial electrode 312 may not be disposed in the coolant outlet OUT3.

Alternatively, unlike what is shown, the sacrificial electrode 310 may not be disposed in the coolant inlet IN3, but the sacrificial electrode 312 may be disposed in the coolant outlet OUT3.

The fuel cell apparatus 100A according to the embodiment may further include an outer coupling member 142.

The outer coupling member 142 is coupled to the outer surface 110BO of the second end plate 110B. Since the outer coupling member 142 is coupled to the second end plate 110B, the outer coupling member 142 may be in contact with the sacrificial electrodes 310 and 312, and accordingly, the sacrificial electrodes 310 and 312 may be fixed and supported by the outer coupling member 142. If the outer coupling member 142 is not present, the sacrificial electrodes 310 and 312 may be easily separated from the coolant inlet IN3 and the coolant outlet OUT3.

The outer surface 110BO is the surface of the second end plate 110B that is opposite the inner surface 110BI of the second end plate 110B, which faces the cell stack 122. Although illustration of the outer coupling member 142 is omitted from FIGS. 1A and 1B, the outer coupling member 142 may be coupled to the outer surface 110BO of the second end plate 110B in the same manner as shown in FIGS. 3 and 4.

Hereinafter, coupling between the second end plate 110B and the sacrificial electrodes 310 and 312 will be described in detail with reference to the accompanying drawings.

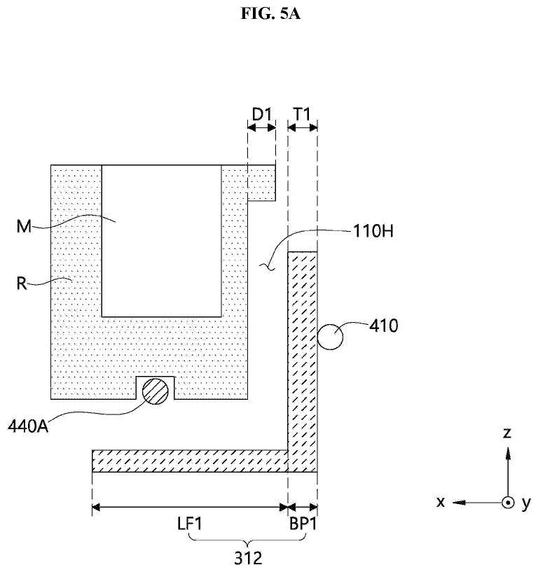

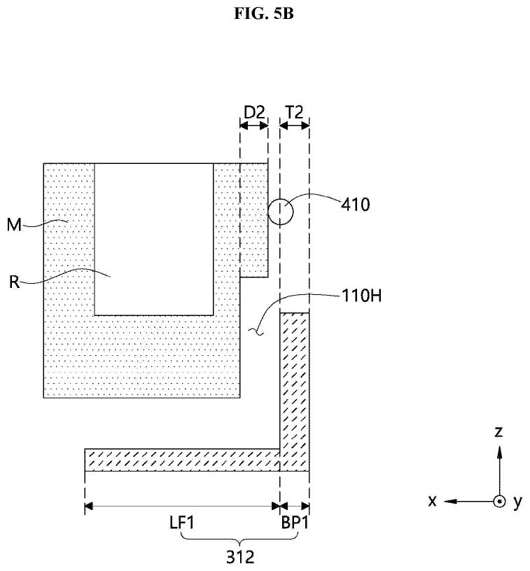

FIG. 5A is a partial exploded cross-sectional view of the sacrificial electrode 312 and the second end plate 110B in the fuel cell apparatus 100A-1 shown in FIG. 3.

FIG. 5B is a partial exploded cross-sectional view of the sacrificial electrode 312 and the second end plate 110B in the fuel cell apparatus 100A-2 shown in FIG. 4.

Although only the sacrificial electrode 312 is shown in FIGS. 5A and 5B, the sacrificial electrode 310 may have the same shape as the sacrificial electrode 312, as described above.

The sacrificial electrode 312 may include a flow path portion LF1 and a bent portion BP1.

The flow path portion LF1 may be disposed on the resin portion R of the second end plate 110B in the flow path in at least one of the coolant inlet IN3 or the coolant outlet OUT3. The bent portion BP1 may be bent and extend from the flow path portion LF1 in the second direction, which is perpendicular to the first direction, and may be disposed between the resin portion R of the second end plate 110B and the outer coupling member 142.

The fuel cell apparatus 100A according to the embodiment may further include at least one sealing member. The at least one sealing member may include a first sealing member 410. The first sealing member 410 may be disposed between the outer surface 110BO of the second end plate 110B and the outer coupling member 142.

The first sealing member 410 may serve to block leakage of water and/or air through a gap between the resin portion R of the second end plate 110B and the outer coupling member 142, thereby ensuring sealing performance. In addition, when the fuel cell apparatus 100A is applied to a vehicle (hereinafter referred to as a “fuel cell vehicle”), the first sealing member 410, which is disposed between the resin portion R and the outer coupling member 142, may prevent the sacrificial electrodes 310 and 312 from being separated due to operation, vibration, shock, or transportation of the fuel cell vehicle.

Referring to FIGS. 5A and 5B, the resin portion R of the second end plate 110B may include a groove portion 110H in which at least part of the bent portion BP1 is disposed.

According to an embodiment, as shown in FIGS. 3 and 5A, the first sealing member 410 may be disposed between the outer coupling member 142 and the bent portion BP1 of the sacrificial electrode 312. According to another embodiment, as shown in FIGS. 4 and 5B, the first sealing member 410 may be disposed between a part of the resin portion R, which is adjacent to the bent portion BP1 of the sacrificial electrode 312 in the second direction, and the outer coupling member 142.

That is, the embodiment shown in FIG. 5A is configured such that the sacrificial electrode 312 is disposed between the first sealing member 410 and the resin portion R of the second end plate 110B, whereas the embodiment shown in FIG. 5B is configured such that the first sealing member 410 is disposed so as to be in direct contact with the metal portion M of the second end plate 110B.

When the components of the fuel cell apparatus 100A-1 are disposed as shown in FIG. 3, the thickness T1 of the bent portion BP1 shown in FIG. 5A in the first direction may be greater than the depth D1 of the groove portion 110H in the first direction. If the thickness T1 is not greater than the depth D1, a sufficient amount of surface pressure may not be supplied to the first and fourth sealing members 410 and 440A.

When the components of the fuel cell apparatus 100A-2 are disposed as shown in FIG. 4, the thickness T2 of the bent portion BP1 shown in FIG. 5B in the first direction may be less than the depth D2 of the groove portion 110H in the first direction. If the thickness T2 is greater than the depth D2, the outer coupling member 142 may be warped due to the coupling force between the outer coupling member 142 and the second end plate 110B, and thus the surface pressure may not be generated uniformly.

The at least one sealing member according to the embodiment may further include fourth sealing members 440A and 440B. The fourth sealing member 440A may be disposed between the resin portion R of the second end plate 110B and the flow path portion LF1 of each of the sacrificial electrodes 310 and 312, and the fourth sealing member 440B may be disposed between the resin portion R of the second end plate 110B and the bent portion BP1 of each of the sacrificial electrodes 310 and 312. Although both the two fourth sealing members 440A and 440B are shown in FIG. 3 for convenience of description, the at least one sealing member according to the embodiment may include only one of the two fourth sealing members 440A and 440B.

The fourth sealing members 440A and 440B may serve to block leakage of water and/or air through gaps between the resin portion R of the second end plate 110B and the sacrificial electrodes 310 and 312, thereby ensuring sealing performance.

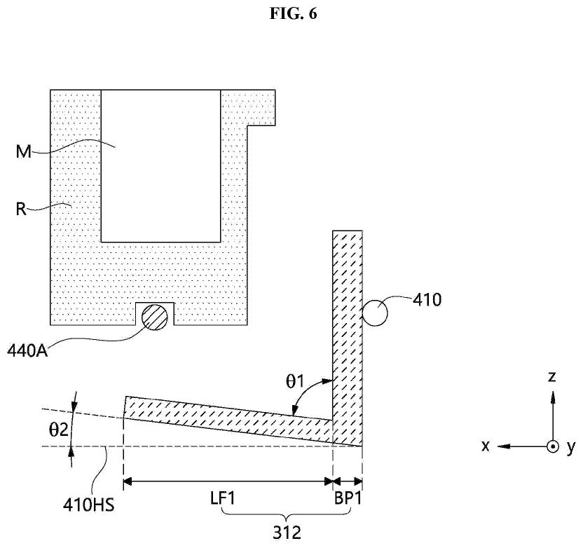

FIG. 6 is an exploded cross-sectional view of the sacrificial electrode 312 and the second end plate 110B shown in FIG. 3.

According to the embodiment, as shown in FIG. 6, an internal bending angle θ1 between the bent portion BP1 and the flow path portion LF1 may be less than 90° by 1° to 5°. That is, the flow path portion LF1 may be inclined toward the bent portion BP1 by a predetermined angle θ2 with respect to a horizontal plane 410HS perpendicular to the bent portion BP1, and the predetermined angle θ2 may be 1° to 5°. However, the embodiments are not limited thereto.

When the sacrificial electrode 312 is formed as shown in FIG. 6, the sacrificial electrode 312 may obtain compressive force (or repulsive force) of the fourth sealing member 440A. That is, since the angle θ1 is set to be less than 90°, elastic force may be applied to the sacrificial electrode 312, thereby generating the surface pressure.

Hereinafter, a fuel cell apparatus 100B according to another embodiment will be described with reference to the accompanying drawings. Unless otherwise specified, the above description of the fuel cell apparatus 100A may also be applied to the fuel cell apparatus 100B, which will be described below.

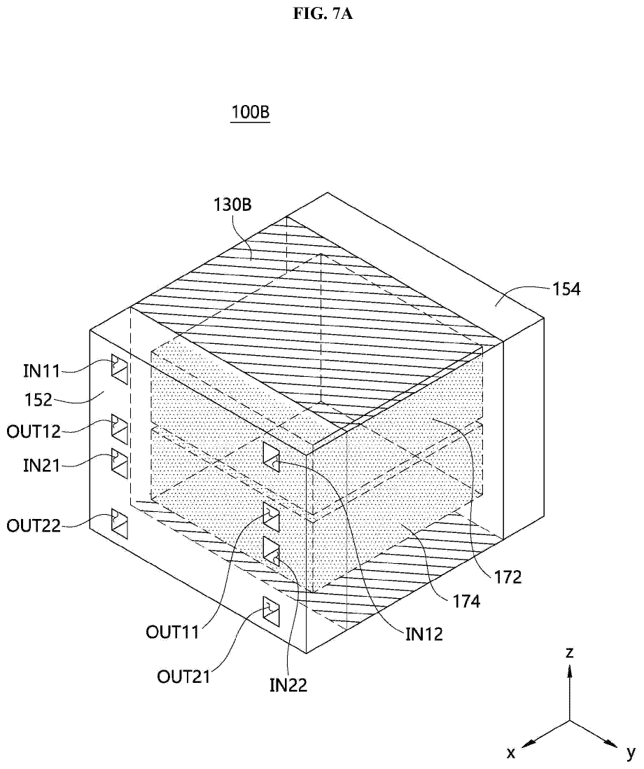

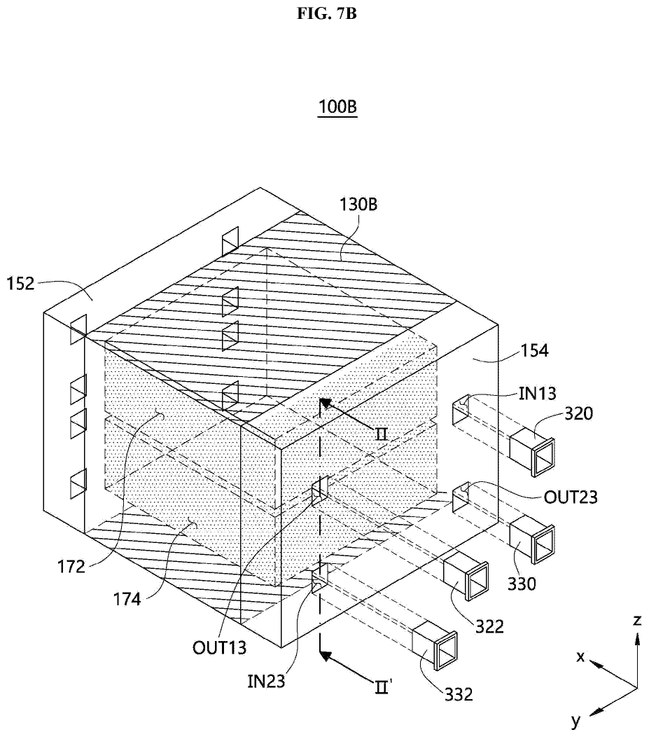

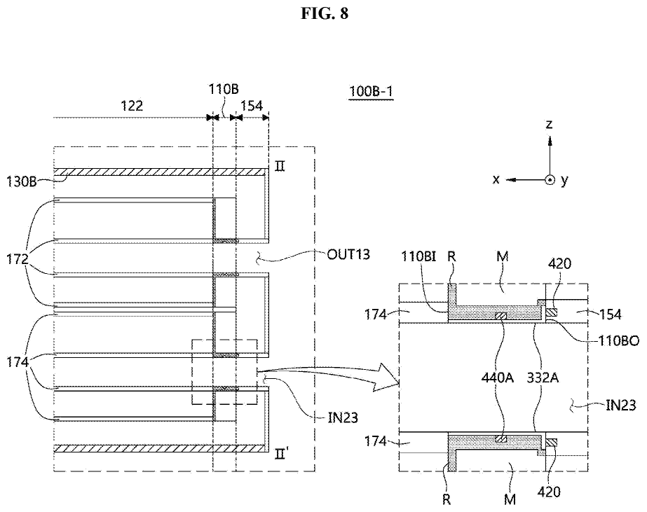

FIG. 7A is a front perspective view of a fuel cell apparatus 100B according to another embodiment, FIG. 7B is a rear perspective view of the fuel cell apparatus 100B according to the other embodiment, and FIG. 8 is a cross-sectional view of an embodiment 100B-1 of the fuel cell apparatus 100B taken along line II-II′ shown in FIG. 7B. A sacrificial electrode 332A shown in FIG. 8 corresponds to an embodiment of the sacrificial electrode 332 shown in FIG. 7B.

The fuel cell apparatus 100B according to the other embodiment may include a plurality of stack modules 172 and 174, an enclosure 130B, a manifold block 152, and a side cover 154.

The plurality of stack modules may be stacked in at least one of the first direction, the second direction, or the third direction. In an example, as shown in the drawings, the plurality of stack modules may include first and second stack modules 172 and 174 stacked in the second direction, but the embodiments are not limited to any specific stacked direction of the plurality of stack modules or any specific number of stack modules stacked.

Each of the plurality of stack modules 172 and 174 may have the same configuration as the fuel cell apparatus 100A shown in FIGS. 1A and 1B, excluding the enclosure 130A. That is, the fuel cell apparatus 100A shown in FIGS. 1A and 1B includes only one stack module, whereas the fuel cell apparatus 100B shown in FIGS. 7A and 7B includes a plurality of stack modules 172 and 174.

Like what is shown in FIG. 2, each of the plurality of stack modules 172 and 174 may include a cell stack 122, end plates 110A and 110B, and a current collector 112. Thus, the same components are denoted by the same reference numerals, and a duplicate description thereof will be omitted. The first end plate 110A of each of the plurality of stack modules 172 and 174 may be disposed between one end of the cell stack 122 of each of the plurality of stack modules 172 and 174 and the manifold block 152, and the second end plate 110B of each of the plurality of stack modules 172 and 174 may be disposed between the other end of the cell stack 122 of each of the plurality of stack modules 172 and 174 and the side cover 154.

The portion denoted by reference numeral “110B” in FIG. 8 is a portion corresponding to the second end plate 110B of each of the first and second stack modules 172 and 174.

That is, as shown in the drawings, the manifold block 152 is disposed on one of both sides of the plurality of stack modules 172 and 174, and the side cover 154 is disposed on the other of both sides of the plurality of stack modules 172 and 174.

The manifold block 152 includes a plurality of fluid inlets IN11, IN12, IN21, and IN22 and a plurality of fluid outlets OUT11, OUT12, OUT21, and OUT22, and the side cover 154 includes a plurality of fluid inlets IN13 and IN23 and a plurality of fluid outlets OUT13 and OUT23.

The plurality of fluid inlets IN11, IN12, and IN13 and the plurality of fluid outlets OUT11, OUT12, and OUT13 are portions through which a fluid flows into and out of the upper stack module 172, and the plurality of fluid inlets IN21, IN22, and IN23 and the plurality of fluid outlets OUT21, OUT22, and OUT23 are portions through which a fluid flows into and out of the lower stack module 174. Therefore, the fluid inlets IN11 and IN21, the fluid inlets IN12 and IN22, and the fluid inlets IN13 and IN23 respectively perform the same functions as the fluid inlet IN1, the fluid inlet IN2, and the fluid inlet IN3 shown in FIGS. 1A and 1B, and the fluid outlets OUT11 and OUT21, the fluid outlets OUT12 and OUT22, and the fluid outlets OUT13 and OUT23 respectively perform the same functions as the fluid outlet OUT1, the fluid outlet OUT2, and the fluid outlet OUT3 shown in FIGS. 1A and 1B. Thus, a duplicate description thereof will be omitted.

That is, the manifold block 152 serves to supply oxygen and hydrogen, which are reactant gases, to each of the first and second stack modules 172 and 174 and to discharge oxygen and hydrogen, which are reactant gases, and condensed water flowing out of each of the first and second stack modules 172 and 174.

In addition, the side cover 154 includes coolant inlets IN13 and IN23 for supplying coolant to the first and second stack modules 172 and 174 and coolant outlets OUT13 and OUT23 for discharging coolant flowing out of the first and second stack modules 172 and 174. In addition, the second end plate 110B included in the stack module 172 may also include a coolant inlet IN13, through which coolant flows into the cell stack 122 and in which the resin portion R is disposed, and a coolant outlet OUT13, through which coolant flowing out of the cell stack 122 is discharged and in which the resin portion R is disposed. In addition, the second end plate 110B included in the stack module 174 may also include a coolant inlet IN23, through which coolant flows into the cell stack 122 and in which the resin portion R is disposed, and a coolant outlet OUT23, through which coolant flowing out of the cell stack 122 is discharged and in which the resin portion R is disposed.

Alternatively, unlike what is shown in FIGS. 7A and 7B, all of the fluid inlets IN11, IN12, IN21, IN22, IN13, and IN23 and the fluid outlets OUT11, OUT12, OUT21, OUT22, OUT13, and OUT23 may be disposed in any one of the manifold block 152 and the side cover 154.

The enclosure 130B may be coupled to the manifold block 152 and the side cover 154 to surround the plurality of stack modules 172 and 174. The enclosure 130B is the same as the above-described enclosure 130A except that the enclosure 130B surrounds a plurality of stack modules, and thus a duplicate description thereof will be omitted.

Although not shown, each of the manifold block 152 and the side cover 154 may include at least one of a metal portion M or a resin portion R.

The description of the metal portion M and the resin portion R of the end plates 110A and 110B included in the fuel cell apparatus 100A may also be applied to the metal portion M and the resin portion R of each of the manifold block 152 and the side cover 154.

In addition, the metal portion M and the resin portion R of the end plates 110A and 110B included in the fuel cell apparatus 100A are respectively the same as the metal portion M and the resin portion R of the end plates 110A and 110B included in each of the plurality of stack modules 172 and 174 of the fuel cell apparatus 100B, and thus a duplicate description thereof will be omitted.

In addition, similar to the fuel cell apparatus 100A according to the embodiment, the fuel cell apparatus 100B according to the other embodiment may include a sacrificial electrode for each of the plurality of stack modules 172 and 174.

In detail, referring to FIG. 7B, one (e.g. 172) of the plurality of stack modules 172 and 174 may include sacrificial electrodes 320 and 322, and the other (e.g. 174) of the plurality of stack modules 172 and 174 may include sacrificial electrodes 330 and 332. Since the sacrificial electrodes 320 and 330 correspond to the above-described sacrificial electrode 310 and the sacrificial electrodes 322 and 332 correspond to the above-described sacrificial electrode 312, a duplicate description of the same parts will be omitted.

The functions of the sacrificial electrodes 320, 322, 330, and 332 are the same as those of the sacrificial electrodes 310 and 312 included in the fuel cell apparatus 100A according to the embodiment described above.

The sacrificial electrodes 320, 322, 330, and 332 may be disposed on the resin portion R of the second end plate 110B, and may be disposed on the resin portion R in the flow path in at least one of the coolant inlets IN13 and IN23 or the coolant outlets OUT13 and OUT23.

Among the sacrificial electrodes 320, 322, 330, and 332 shown in FIG. 7B, only the sacrificial electrodes 322 and 332, particularly the sacrificial electrode 332, will be described. Since the other sacrificial electrodes 320, 322, and 330 have the same cross-sectional shape as the sacrificial electrode 332, the following description of the sacrificial electrodes 332, 332A, and 332B may also be applied to the other sacrificial electrodes 320, 322, and 330. That is, the sacrificial electrodes 320, 322, and 330 may be disposed in the coolant inlet IN13 and the coolant outlets OUT13 and OUT23 in the same manner as the sacrificial electrode 332A is disposed in the coolant inlet IN23, as shown in FIG. 8.

In addition, the fuel cell apparatus 100B according to another embodiment may include at least one sealing member.

The at least one sealing member may include a second sealing member 420. The second sealing member 420 may be disposed between the side cover 154 and the outer surface 110BO of the second end plate 110B that is opposite the inner surface 110BI of the second end plate 110B, which faces the cell stack 122.

Similar to the sacrificial electrode 312 shown in FIGS. 5A and 5B, the sacrificial electrode 332A shown in FIG. 8 may include a flow path portion and a bent portion.

The flow path portion of the sacrificial electrode 332A may be disposed on the resin portion R in the flow path in at least one of the coolant inlets IN13 and IN23 or the coolant outlets OUT13 and OUT23. The bent portion of the sacrificial electrode 332A may be bent and extend from the flow path portion of the sacrificial electrode 332A in the second direction, which is perpendicular to the first direction, and may be disposed between the resin portion R of the second end plate 110B and the side cover 154.

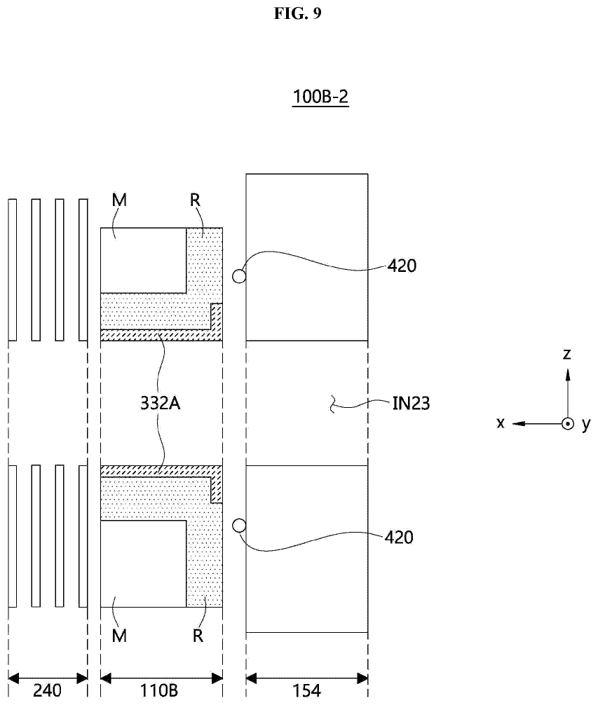

FIG. 9 is a partial cross-sectional view of another embodiment 100B-2 of the fuel cell apparatus 100B. For convenience of explanation, FIG. 9 shows the second end plate 110B of the stack module 174 shown in FIG. 7B and the separator 240 of the cell stack 122 shown in FIG. 2, and illustration of the enclosure 130B shown in FIG. 7B and the current collector 112 shown in FIG. 2 is omitted from FIG. 9. The separator 240 shown in FIG. 9 corresponds to the separators 242 and 244 of each unit cell shown in FIG. 2. The sacrificial electrode 332A shown in FIG. 9 corresponds to an embodiment of the sacrificial electrode 332 shown in FIG. 7B.

According to an embodiment, as shown in FIG. 8, the second sealing member 420 may be disposed between the side cover 154 and the bent portion of the sacrificial electrode 332A.

According to another embodiment, as shown in FIG. 9, the second sealing member 420 may be disposed between a part of the resin portion R, which is adjacent to the bent portion of the sacrificial electrode 332A in the second direction, and the side cover 154.

The embodiment shown in FIG. 8 is configured such that the sacrificial electrode 332A is disposed between the second sealing member 420 and the second end plate 110B, whereas the embodiment shown in FIG. 9 is configured such that the second sealing member 420 is in direct contact with the resin portion R of the second end plate 110B, without the sacrificial electrode 332A being interposed therebetween.

The second sealing member 420 may serve to block leakage of water and/or air through a gap between the second end plate 110B and the side cover 154, thereby ensuring sealing performance. In addition, since the second sealing member 420 is disposed between the resin portion R of the second end plate 110B and the side cover 154, it is possible to prevent the sacrificial electrode 332A from being separated due to operation, vibration, shock, or transportation of the fuel cell vehicle.

The resin portion R of the second end plate 110B included in each of the plurality of stack modules 172 and 174 may include a groove portion in which at least part of the bent portion is disposed, as shown in FIGS. 5A and 5B.

If the fuel cell apparatus 100B-1 has the configuration shown in FIG. 8, the thickness of the bent portion of the sacrificial electrode 332A in the first direction may be greater than the depth of the groove portion in the first direction, as shown in FIG. 5A. If the thickness of the bent portion of the sacrificial electrode 332A in the first direction is not greater than the depth of the groove portion in the first direction, a sufficient amount of surface pressure may not be supplied to the second and fourth sealing members 420 and 440A.

If the fuel cell apparatus 100B-2 has the configuration shown in FIG. 9, the thickness of the bent portion of the sacrificial electrode 332A in the first direction may be less than the depth of the groove portion in the first direction, as shown in FIG. 5B. If the thickness of the bent portion of the sacrificial electrode 332A in the first direction is greater than the depth of the groove portion in the first direction, the side cover 154 may be warped due to the coupling force between the side cover 154 and the second end plate 110B, and thus the surface pressure may not be generated uniformly.

In the fuel cell apparatuses 100B-1 and 100B-2 shown in FIGS. 8 and 9, since the side cover 154 is in contact with the sacrificial electrode 332A, the sacrificial electrode 332A may be fixed and supported by the side cover 154. Accordingly, if the side cover 154 is not present, the sacrificial electrode 332A may be easily separated.

For example, the side cover 154 may be formed as a resin member. The resin member forming the side cover 154 may be made of the same material as the resin portion R of the second end plate 110B.

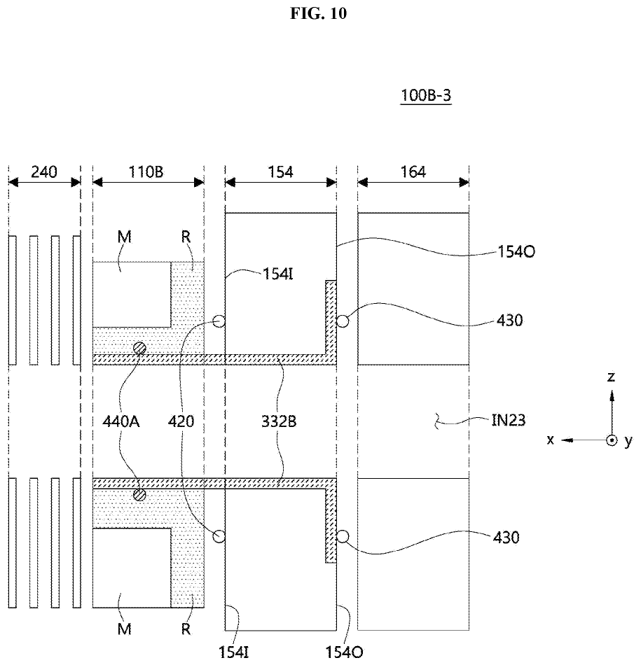

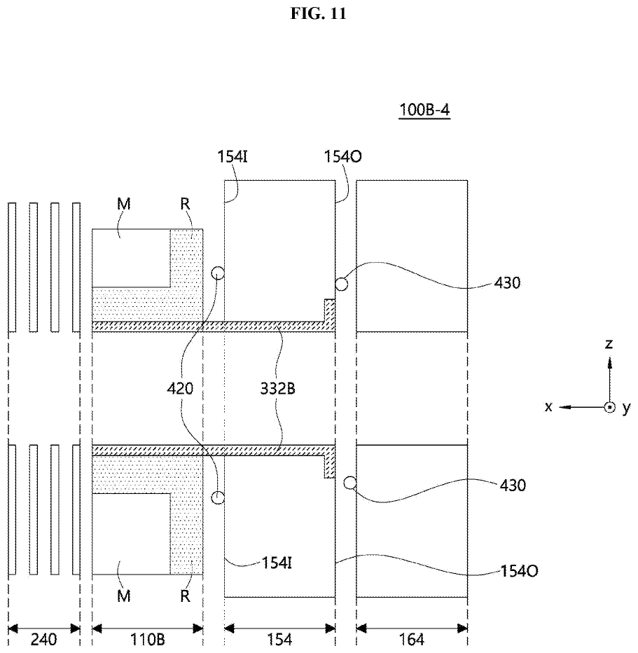

FIGS. 10 and 11 are partial cross-sectional views of embodiments 100B-3 and 100B-4 of the fuel cell apparatus 100B. Similar to FIG. 9, for convenience of explanation, FIGS. 10 and 11 show the second end plate 110B of the stack module 174 shown in FIG. 7B and the separator 240 of the cell stack 122 shown in FIG. 2, and illustration of the enclosure 130B shown in FIG. 7B and the current collector 112 shown in FIG. 2 is omitted from FIGS. 10 and 11. The separator 240 shown in FIGS. 10 and 11 corresponds to the separators 242 and 244 of each unit cell shown in FIG. 2. The sacrificial electrode 332B shown in FIGS. 10 and 11 corresponds to an embodiment of the sacrificial electrode 332 shown in FIG. 7B.

As shown in FIGS. 10 and 11, each of the fuel cell apparatuses 100B-3 and 100B-4 according to other embodiments may further include an outer coupling member 164, unlike the fuel cell apparatuses 100B-1 and 100B-2.

The outer coupling member 164 may be coupled to the outer surface 154O of the side cover 154. The outer surface 154O corresponds to a surface opposite the inner surface 154I of the side cover 154, which faces the second end plate 110B. Although illustration thereof is omitted from FIGS. 7A and 7B, the outer coupling member 164 may be coupled to the side cover 154 in the same manner as shown in FIGS. 10 and 11.

According to the embodiment, each of the outer coupling members 142 and 164 shown in FIGS. 3, 4, 10, and 11 may include a coolant driving device component (balance of plant (BOP)), which assists in operation of the fuel cell, and may include a pipe.

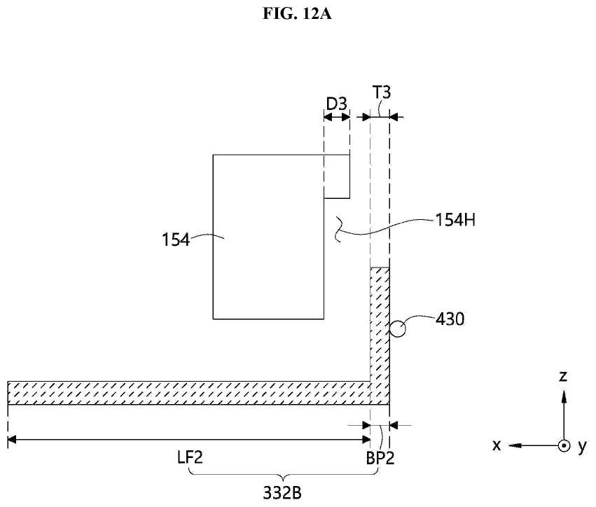

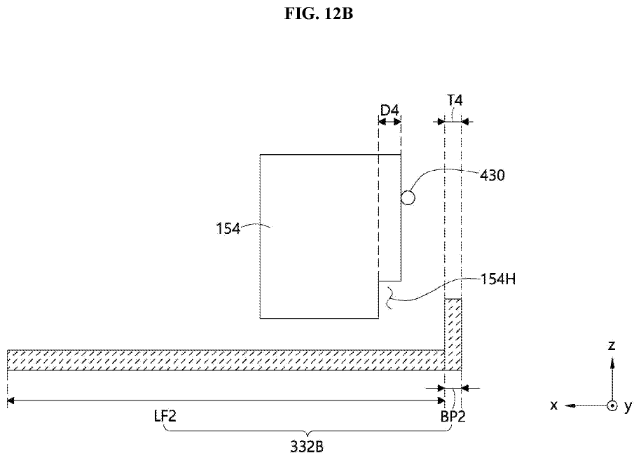

FIG. 12A is a partial exploded cross-sectional view of the fuel cell apparatus 100B-3 shown in FIG. 10, and FIG. 12B is a partial exploded cross-sectional view of the fuel cell apparatus 100B-4 shown in FIG. 11. For convenience of description, the side cover 154 and the sacrificial electrode 332B will be mainly described with reference to FIGS. 12A and 12B.

As shown in FIGS. 12A and 12B, the sacrificial electrode 332B of each of the fuel cell apparatuses 100B-3 and 100B-4 shown in FIGS. 10 and 11 may include a flow path portion LF2 and a bent portion BP2.

The flow path portion LF2 may be disposed on the resin portion R in the flow path in at least one of the coolant inlets IN13 and IN23 or the coolant outlets OUT13 and OUT23.

The bent portion BP2 may be bent and extend from the flow path portion LF2 in the second direction, which is perpendicular to the first direction, and may be disposed between the side cover 154 and the outer coupling member 164.

As shown in FIGS. 10 and 11, the second sealing member 420 may be disposed between the side cover 154 and the resin portion R of the second end plate 110B.

In addition, the at least one sealing member may further include a third sealing member. The third sealing member 430 may be disposed between the outer coupling member 164 and the side cover 154.

According to an embodiment, as shown in FIGS. 10 and 12A, the third sealing member 430 may be disposed between the outer coupling member 164 and the bent portion BP2 of the sacrificial electrode 332B. According to another embodiment, as shown in FIGS. 11 and 12B, the third sealing member 430 may be disposed between a portion of the side cover 154, which is adjacent to the bent portion BP2 of the sacrificial electrode 332B in the second direction, and the outer coupling member 164.

Referring to FIGS. 12A and 12B, the side cover 154 may include a groove portion 154H in which at least part of the bent portion BP2 is disposed.

The embodiment shown in FIG. 12A is configured such that the third sealing member 430 is disposed so as to be in contact with the sacrificial electrode 332B, whereas the embodiment shown in FIG. 12B is configured such that the third sealing member 430 is disposed so as to be in direct contact with the side cover 154.

The third sealing member 430 may serve to block leakage of water and/or air through a gap between the side cover 154 and the outer coupling member 164, thereby ensuring sealing performance. In addition, since the third sealing member 430 is disposed between the side cover 154 and the outer coupling member 164, it is possible to prevent the sacrificial electrode 332B from being separated due to operation, vibration, shock, or transportation of the fuel cell vehicle.

The thickness T3 of the bent portion BP2 shown in FIG. 12A in the first direction may be greater than the depth D3 of the groove portion 154H in the first direction. If the thickness T3 is not greater than the depth D3, a sufficient amount of surface pressure may not be supplied to the third and fourth sealing members 430 and 440A.

The thickness T4 of the bent portion BP2 shown in FIG. 12B in the first direction may be less than the depth D4 of the groove portion 154H in the first direction. If the thickness T4 is greater than the depth D4, the outer coupling member 164 may be warped due to the coupling force between the outer coupling member 164 and the side cover 154, and thus the surface pressure may not be generated uniformly.

For example, the above-described thicknesses T1, T2, T3, and T4 may be about 1 mm.

In the fuel cell apparatuses 100B-3 and 100B-4 shown in FIGS. 10 and 11, since the outer coupling member 164 is in contact with the sacrificial electrode 332B, the sacrificial electrode 332B may be fixed and supported by the outer coupling member 164. Accordingly, if the outer coupling member 164 is not present, the sacrificial electrode 332B may be easily separated.

The above-described first to fourth sealing members 410, 420, 430, 440A, and 440B are a type of gasket, and may be made of the same material as the above-described gaskets 232, 234, and 236.

Hereinafter, a fuel cell apparatus according to a comparative example and the fuel cell apparatus according to the embodiment will be described with reference to the accompanying drawings.

In the case of a sacrificial electrode included in the fuel cell apparatus according to the comparative example, a plate, which has the same shape as but a different base material from a separator, is disposed on an end cell, or a plate, which is formed in the shape of a communication portion contacting the separator, is integrated with and disposed on a communication portion of the end plate. When the sacrificial electrode is corroded and reaches the end of its lifespan, the sacrificial electrode needs to be replaced. However, the above disposition structure of the sacrificial electrode makes it difficult to replace the sacrificial electrode. That is, in the case of the comparative example, a clamping member, such as a clamping bar or an enclosure, needs to be removed in order to replace the sacrificial electrode.

In contrast, in the case of the fuel cell apparatuses 100A and 100B according to the embodiments, after the sacrificial electrodes 310, 312, 320, 322, 330, 332, 332A, and 332B are inserted into the coolant inlets IN3, IN13, and IN23 or the coolant outlets OUT3, OUT13, and OUT23, the outer coupling members 142 and 164 or the side cover 154 may be brought into surface contact with the sacrificial electrodes 310, 312, 320, 322, 330, 332, 332A, and 332B, whereby the sacrificial electrodes 310, 312, 320, 322, 330, 332, 332A, and 332B may be fixed without being separated. Further, it is possible to easily separate the sacrificial electrodes 310, 312, 320, 322, 330, 332, 332A, and 332B from the coolant inlets IN3, IN13, and IN23 or the coolant outlets OUT3, OUT13, and OUT23 by removing the outer coupling members 142 and 164 or the side cover 154. As described above, according to the embodiments, the sacrificial electrodes 310, 312, 320, 322, 330, 332, 332A, and 332B may be easily mounted or demounted, i.e. replaced, without the necessity to remove the stack clamping member merely by assembling or disassembling the outer coupling members 142 and 164 or the side cover 154. As a result, repair and maintenance of the fuel cell apparatuses may be simplified.

In addition, since corrosion of the separator 240 is suppressed by the sacrificial electrodes 310, 312, 320, 322, 330, 332, 332A, and 332B, the lifespan and durability of the cell stack 122 may be increased.

In addition, it is possible to increase surface pressure by adjusting the thicknesses T1, T2, T3, and T4 of the sacrificial electrodes and the depths D1, D2, D3, and D4 of the groove portions, thereby improving the airtightness of the stack.

The fuel cell apparatuses according to the above-described embodiments may be applied to vehicles, aircraft, ships, stationary power generation systems, and the like, without being limited thereto.

As is apparent from the above description, according to the fuel cell apparatuses according to the embodiments, the sacrificial electrode may be easily mounted or demounted, i.e. replaced, without the necessity to remove a stack clamping member merely by assembling or disassembling the outer coupling member or the side cover. Accordingly, repair and maintenance of the fuel cell apparatuses may be simplified. In addition, since corrosion of the separator is suppressed by the sacrificial electrode, the lifespan and durability of the cell stack may be increased. In addition, it is possible to increase surface pressure by adjusting the thickness of the sacrificial electrode and the depth of the groove portion, thereby improving the airtightness of the stack. In addition, leakage of water and/or air through a gap between the second end plate and the outer coupling member, between the second end plate and the side cover, between the side cover and the outer coupling member, or between the second end plate and the sacrificial electrode may be blocked by a sealing member, whereby sealing performance may be ensured. In addition, it is possible to prevent the sacrificial electrode from being separated due to operation, vibration, shock, or transportation of a fuel cell vehicle.

However, the effects achievable through the disclosure are not limited to the above-mentioned effects, and other effects not mentioned herein will be clearly understood by those skilled in the art from the above description.

The above-described various embodiments may be combined with each other without departing from the scope of the present disclosure unless they are incompatible with each other.

In addition, for any element or process that is not described in detail in any of the various embodiments, reference may be made to the description of an element or a process having the same reference numeral in another embodiment, unless otherwise specified.

While the present disclosure has been particularly shown and described with reference to exemplary embodiments thereof, these embodiments are only proposed for illustrative purposes, and do not restrict the present disclosure, and it will be apparent to those skilled in the art that various changes in form and detail may be made without departing from the essential characteristics of the embodiments set forth herein. For example, respective configurations set forth in the embodiments may be modified and applied. Further, differences in such modifications and applications should be construed as falling within the scope of the present disclosure as defined by the appended claims.

What is claimed is:

1. A fuel cell apparatus, comprising:
a cell stack comprising a plurality of unit cells stacked in a first direction;
first and second end plates disposed on respective lateral ends of the cell stack, each of the first and second end plates being formed such that a metal portion is enveloped by a resin portion;
a sacrificial electrode disposed on a resin portion of the second end plate adjacent to a cell having a highest potential among the plurality of unit cells, among the first and second end plates;
an outer coupling member coupled to an outer surface of the second end plate so as to be in contact with and support the sacrificial electrode, the outer surface being opposite an inner surface of the second end plate, the inner surface facing the cell stack; and
a first sealing member disposed between the outer surface of the second end plate and the outer coupling member.

2. The fuel cell apparatus according to claim 1, wherein the second end plate comprises:
a coolant inlet formed to allow a coolant to flow into the cell stack therethrough and to allow the resin portion to be disposed therein; and
a coolant outlet formed to allow a coolant flowing out of the cell stack to be discharged therethrough and to allow the resin portion to be disposed therein, and
wherein the sacrificial electrode comprises:
a flow path portion disposed on the resin portion in a flow path in at least one of the coolant inlet or the coolant outlet; and
a bent portion bent and extending from the flow path portion in a second direction so as to be disposed between the resin portion of the second end plate and the outer coupling member, the second direction being perpendicular to the first direction.

3. The fuel cell apparatus according to claim 2, wherein the first sealing member is disposed between the outer coupling member and the bent portion of the sacrificial electrode.

4. The fuel cell apparatus according to claim 2, wherein the first sealing member is disposed between the resin portion adjacent to the bent portion of the sacrificial electrode in the second direction and the outer coupling member.

5. A fuel cell apparatus, comprising:
a plurality of stack modules;
a manifold block disposed on one of two lateral ends of the plurality of stack modules; and
a side cover disposed on a remaining one of the two lateral ends of the plurality of stack modules,
wherein each of the plurality of stack modules comprises:
a cell stack comprising a plurality of unit cells stacked in a first direction;
first and second end plates respectively disposed between one lateral end of the cell stack and the manifold block and between an opposite lateral end of the cell stack and the side cover, each of the first and second end plates being formed such that a metal portion is enveloped by a resin portion;
a sacrificial electrode disposed on a resin portion of the second end plate adjacent to a cell having a highest potential among the plurality of unit cells, among the first and second end plates; and
a second sealing member disposed between an outer surface of the second end plate and the side cover, the outer surface being opposite an inner surface of the second end plate, the inner surface facing the cell stack.

6. The fuel cell apparatus according to claim 5, further comprising:
an outer coupling member coupled to an outer surface of the side cover, the outer surface being opposite an inner surface of the side cover, the inner surface facing the second end plate.

7. The fuel cell apparatus according to claim 6, wherein the second end plate included in each of the plurality of stack modules comprises:
a coolant inlet formed to allow a coolant to flow into the cell stack therethrough and to allow the resin portion to be disposed therein; and
a coolant outlet formed to allow a coolant flowing out of the cell stack to be discharged therethrough and to allow the resin portion to be disposed therein.

8. The fuel cell apparatus according to claim 7, wherein the sacrificial electrode comprises a flow path portion disposed on the resin portion in a flow path in at least one of the coolant inlet or the coolant outlet.

9. The fuel cell apparatus according to claim 8, wherein the sacrificial electrode comprises a bent portion bent and extending from the flow path portion in a second direction so as to be disposed between the resin portion of the second end plate and the side cover, the second direction being perpendicular to the first direction.

10. The fuel cell apparatus according to claim 9, wherein the second sealing member is disposed between the side cover and the bent portion.

11. The fuel cell apparatus according to claim 9, wherein the second sealing member is disposed between the resin portion adjacent to the bent portion of the sacrificial electrode in the second direction and the side cover.

12. The fuel cell apparatus according to claim 8, wherein the sacrificial electrode comprises a bent portion bent and extending from the flow path portion in a second direction so as to be disposed between the side cover and the outer coupling member, the second direction being perpendicular to the first direction.

13. The fuel cell apparatus according to claim 12, wherein the second sealing member is disposed between the side cover and the resin portion of the second end plate.

14. The fuel cell apparatus according to claim 12, further comprising:
a third sealing member disposed between the outer coupling member and the side cover.

15. The fuel cell apparatus according to claim 14, wherein the third sealing member is disposed between the outer coupling member and the bent portion of the sacrificial electrode.

16. The fuel cell apparatus according to claim 14, wherein the third sealing member is disposed between the side cover adjacent to the bent portion of the sacrificial electrode in the second direction and the outer coupling member.

17. The fuel cell apparatus according to claim 10, further comprising:
a fourth sealing member disposed between the resin portion of the second end plate and the flow path portion or between the resin portion of the second end plate and the bent portion.

18. The fuel cell apparatus according to claim 17, wherein a bending angle between the bent portion and the flow path portion is less than 90° by 1° to 5°.

19. The fuel cell apparatus according to claim 10, wherein the resin portion of the second end plate has a groove portion formed therein to allow at least part of the bent portion to be disposed therein, and
wherein the bent portion has a thickness in the first direction, and the thickness is greater than a depth of the groove portion in the first direction.

20. The fuel cell apparatus according to claim 11, wherein the resin portion of the second end plate has a groove portion formed therein to allow at least part of the bent portion to be disposed therein, and
wherein the bent portion has a thickness in the first direction, and the thickness is less than a depth of the groove portion in the first direction.
